(19) United States
(12) Patent Application Publication
(10) Pub. No.: US 2003/0000636 A1
(43) Pub. Date: Jan. 2, 2003

(54) Shoulder strap pad assembly

(75) Inventor: Gloria Falla, Demarest, NJ (US)

Correspondence Address: CHARLES N.J. RUGGIERO, ESQ., OHLANDT, GREELEY, RUGGIERO & PERLE, L.L.P., 10th FLOOR, ONE LANDMARK SQUARE, STAMFORD, CT, 06901-2682, US

(73) Assignee: Playtex Apparel, Inc.

(21) Appl. No.: 10/108,761

(22) Filed: Mar. 28, 2002

Related U.S. Application Data
(63) Continuation-in-part of application No. 09/896,049, filed on Jun. 29, 2001.

(51) Int. Cl. B32B 31/00

(52) U.S. Cl. 156/250; 428/317.1

(57) ABSTRACT

A shoulder strap pad assembly is provided that includes: a top cover, a bottom cover, and a cushion filler. The bottom cover is laminated to the top cover to form an enclosure in which the cushion filler is secured. The top cover has a top fabric layer, a first adhesive web layer positioned below the top fabric layer and a first base layer positioned below the first adhesive layer on a side opposite that of the top fabric layer. The bottom cover has a second base layer, a second adhesive web layer positioned above the second base layer. The cushion filler has a cushion layer, a third adhesive web layer positioned above the cushion layer, a fourth adhesive web layer positioned below the cushion layer, and a third base layer positioned below the fourth adhesive web layer. In a preferred embodiment, the pad assembly is attached to a piece of fabric to form a channel in which a brassiere shoulder strap is positioned. In a alternative embodiment, the pad assembly is integrally formed with the brassiere shoulder strap.

### RELATED APPLICATION

This application is a continuation in part of U.S. Ser. No. 09/896,049 filed Jun. 29, 2001.

### BACKGROUND OF THE INVENTION

1. Field of the Invention

The present invention relates generally to a shoulder strap pad. More particularly the present invention relates to a shoulder strap pad for use in a brassiere shoulder strap and a method of making the shoulder strap pad.

2. Description of the Prior Art

A well known problem associated with a brassiere shoulder strap is the discomfort caused by the strap on the shoulder of the wearer. Specifically, each brassiere strap will normally cause either a depression or irritation in the shoulder and may even interfere with arterial or venous drainage. Numerous attempts have been made to relieve this discomfort. Some attempts have included use of shoulder pads of cotton or foam rubber that are interposed between the strap and the wearer's shoulder or releasably attachable to the strap.

Significantly, such pads have proven to be bulky and unsightly. Also, there are inconveniences attendant with such attachments since such pads will need to be removed, and subsequently reattached, each time the brassiere is washed.

Some brassiere straps have attempted to incorporate a pad structure in the strap itself. Such brassiere straps may have achieved a modicum of success in relieving discomfort. However, such brassieres have limited user life since they fail to maintain their desired appearance after several machine washings apparently due to the affect cleaning detergents have on the construction and materials of the brassiere strap. For example, pads and straps made of foam have been found to yellow after a few washings. It is also common that brassieres that have incorporated a pad therein have a knotted or bumpy appearance after repeated machine washings.

Other attempts to relieve discomfort, yet provide a modicum of pleasing appearance, have included widening the shoulder strap to better distribute the weight in the shoulder area. Still other attempts have been to incorporate elastic bands with a padded cover in the strap to provide more flexibility and thus attempt to better distribute the pressure in the shoulder area.

All such attempts have, heretofore, failed to achieve the desired results, namely relief of the discomfort in the shoulder area, with a smooth attractive appearance that is maintained even after repeated wear and machine washing. Thus, long wear life and comfort have evaded prior art shoulder straps.

### SUMMARY OF THE INVENTION

It is an object of the present invention to provide a shoulder strap pad that alleviates discomfort and irritation.

It is another object of the present invention to provide a shoulder strap pad that has an attractive, non-bulky appearance.

It is a still another object of the present invention to provide a shoulder strap pad that is resistant to bunching even after extended use and repeated washings.

It is a further object of the present invention to provide such a shoulder strap pad that is made of materials and constructed to achieve long wear life.

These and other objects and advantages of the present invention are achieved by a shoulder strap pad assembly that includes: a top cover, a bottom cover, and a cushion filler. The bottom cover is laminated to the top cover to form an enclosure in which the cushion filler is secured. The top cover has a top fabric layer, a first adhesive web layer positioned below the top fabric layer and a first base layer positioned below the first adhesive layer on a side opposite that of the top fabric layer. The bottom cover has a second base layer, a second adhesive web layer positioned above the second base layer. The cushion filler has a cushion layer, a third adhesive web layer positioned above the cushion layer, a fourth adhesive web layer positioned below the cushion layer, and a third base layer positioned below the fourth adhesive web layer. In a preferred embodiment, the pad assembly is attached to a piece of fabric to form a channel in which a brassiere shoulder strap is positioned. In a alternative embodiment, the pad assembly is integrally formed with the brassiere shoulder strap.

### BRIEF DESCRIPTION OF THE DRAWINGS

FIG. 1 is a rear perspective view of a brassiere having a pair of shoulder straps, each incorporating the shoulder strap pad of the present invention;

FIG. 2 is a top view of the preferred embodiment of the shoulder strap pad of FIG. 1;

FIG. 3 is a cross-sectional view of the shoulder strap pad taken along line 5-5 of FIG. 2; and

FIG. 4 is schematic drawing of the breakdown of the components of the shoulder strap pad of FIG. 2.

### DETAILED DESCRIPTION OF THE INVENTION

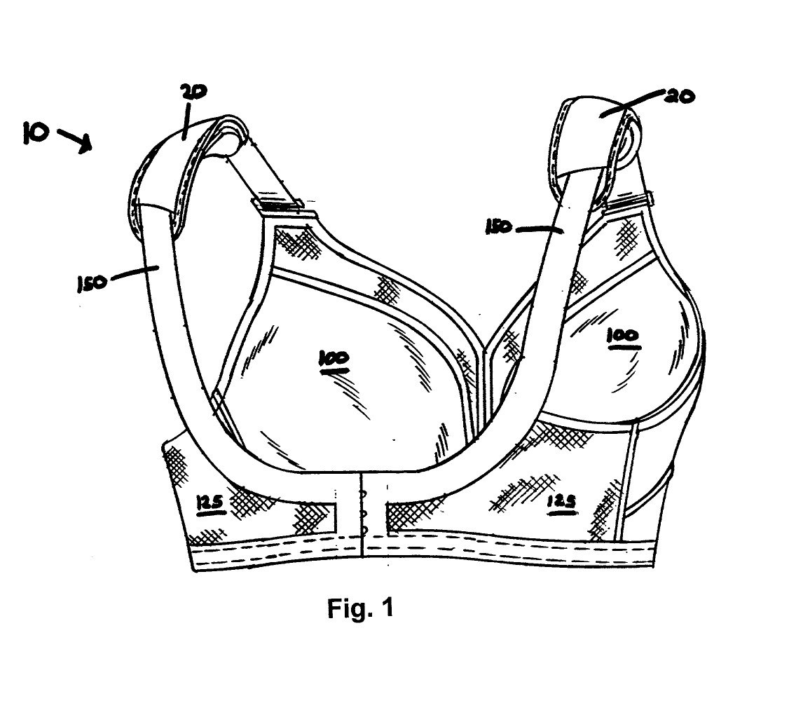

Referring to the figures and, in particular, FIG. 1, there is provided a brassiere generally represented by reference numeral 10. Brassiere 10 includes a pair of breast cups 100, a pair of back panels 125, and a pair of shoulder straps 150. Each shoulder strap 150 has a shoulder strap pad 20.

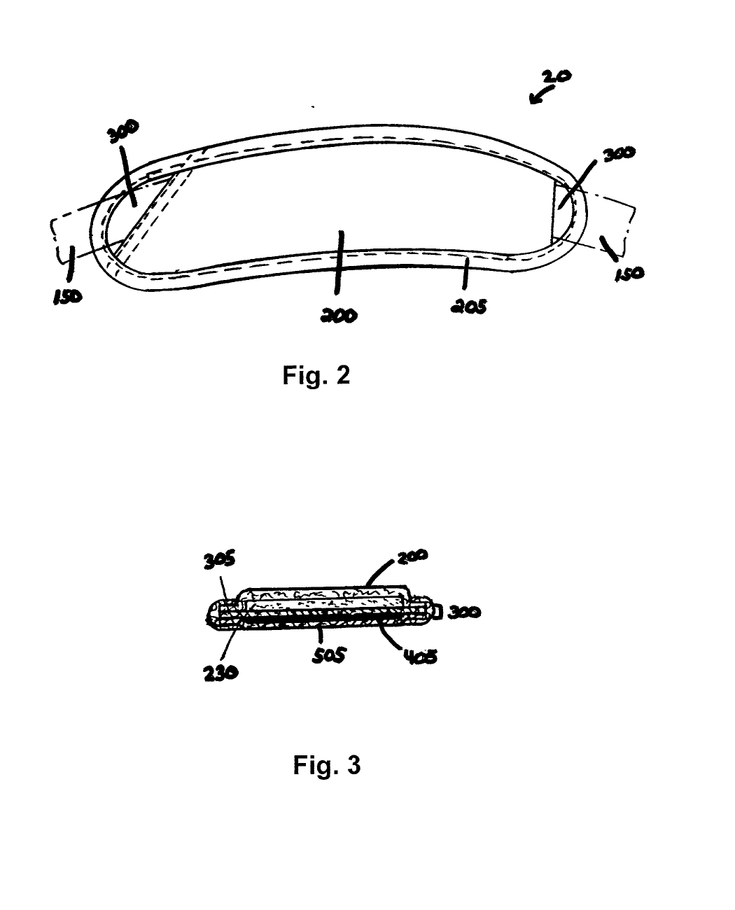

In a preferred embodiment, shown in FIG. 2, shoulder strap pad 20 is made of a pad assembly 300 and a fabric cover 200. Pad assembly 300 is connected to fabric cover 200 by a binder 205. As shown in FIG. 3, the attachment of pad assembly 300 to fabric cover 200 form a channel 230 in which brassiere strap 150 is positioned.

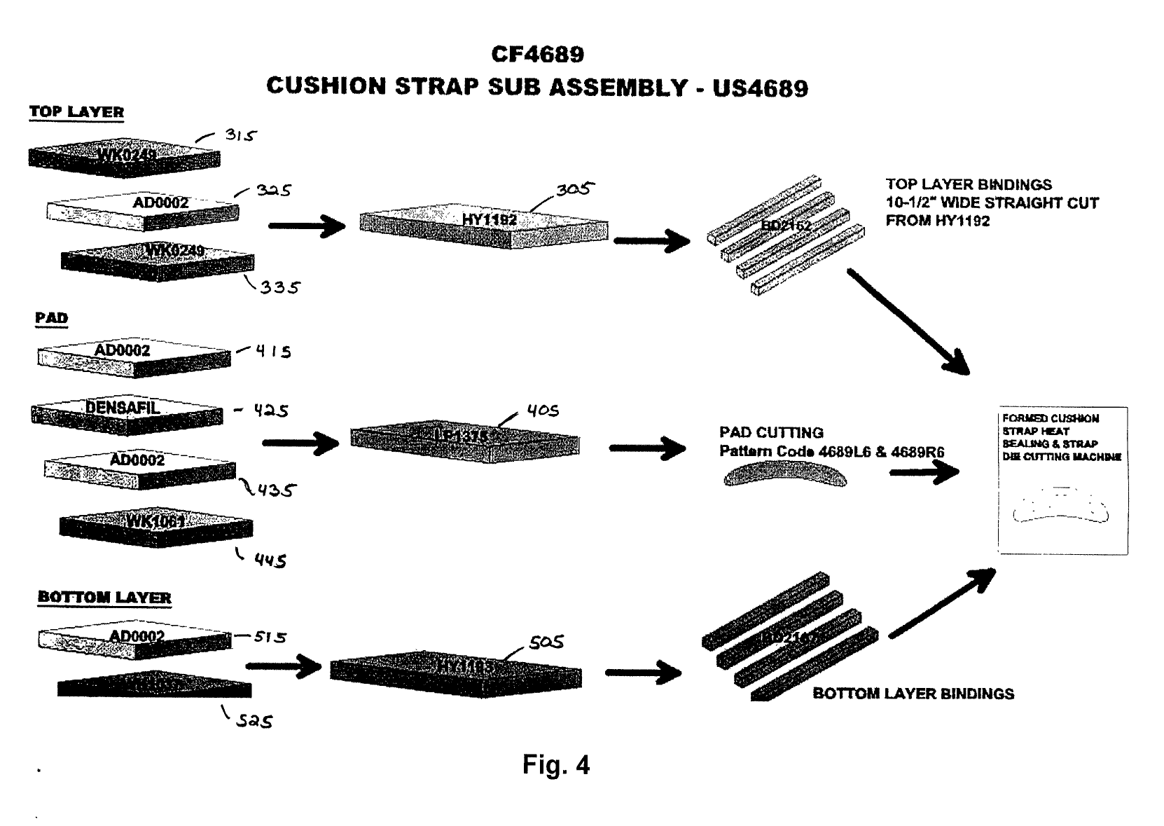

Referring to FIG. 4, pad assembly 300 includes nine layers of material and adhesive. These nine layers can be broken-down into three portions, namely a top cover 305, a bottom cover 505, and a cushion filler 405 that is positioned between the top and bottom covers. In an alternative embodiment, the number of layers of material and adhesive may vary depending upon the needs of the brassiere manufacturer.

Top cover 305 includes a first top fabric layer 315, a first adhesive web layer 325 and a first base layer 335. Top fabric layer 315 is positioned on one side of first adhesive web layer 325, while first base layer 335 is positioned on the side of first adhesive web layer 325 opposite that of first top fabric layer 315. First top fabric layer 315 and first base layer 335 are made of a one hundred percent nylon yarn. Preferably, top fabric layer 315 and first base layer 335 are made of a three bar tricot or knit marquisette fabric.

First adhesive web layer 325 is not merely adhesive, but is a fibrous sheet of adhesive web. A web of adhesive is desired since it will readily migrate into adjacent layers, such as top fabric layer 315 and first base layer 335, during the lamination process. In the preferred embodiment, first adhesive web layer 325 is made of any adhesive nylon web that is one hundred percent polyamide adhesive net. It has a fusing temperature range of 200 to 230 degrees Fahrenheit. This material can withstand washing and dry cleaning when heavier amounts of adhesive are used. This adhesive web, as used in top layer 305, bottom layer 505, and cushion filler 405 of pad assembly 300, is about 0.6 ounces per square yard (oz./sq.yd.).

Bottom cover 505 includes a second base layer 525 and a second adhesive web layer 515. Second web adhesive layer 515 is positioned on one side of second base layer 525, while the opposite side of second base layer 525 forms the outer or bottom part of the strap that contacts the skin of the wearer. Second base layer 525 is made of one hundred percent polyester fleece. Preferably, second base layer 525 is made of a two bar tricot knit fabric. Second adhesive web layer 515 is preferably identical in composition to first adhesive web layer 325.

Cushion filler 405 has a cushion layer 425, a third adhesive web layer 415, a fourth adhesive web layer 435, and third base layer 445. Cushion layer 425 is positioned between third adhesive web layer 415 and fourth adhesive web layer 435. Third adhesive web layer 415 and fourth adhesive web layer 445 are preferably identical in composition to first adhesive web layer 325. Third base layer 445 is positioned on the side of fourth adhesive web layer 435 opposite that of cushion layer 425. Third base layer 445 is made of 100 percent polyester. Preferably, third base layer 445 is made of mesh. Cushion layer 425 is made of Densafil®, a one hundred percent polyester non-woven fiber web.

Thus, in the most preferred embodiment of the present invention, the pad assembly includes the following layers in sequential order from the top of the brassiere strap: first top fabric layer 315, first adhesive web layer 325, first base layer 335, third adhesive web layer 415, cushion layer 425, fourth adhesive web layer 435, third base layer 445, second adhesive web layer 515, and second base layer 525.

Shoulder strap pad 20 is made by laminating the various components together using the following method. First top fabric layer 315, first adhesive web layer 325, and first base layer 335 are laminated together to form top cover 305 of pad assembly 300. Second adhesive layer 515 and second base layer 525 are laminated together to form bottom cover of 505 of pad assembly 300. Top cover 305 and bottom cover 505 are then laminated together by heat and adhesive to form an enclosure that receives cushion filler 405.

This combination of material and adhesive in the shoulder strap pad of the present invention create a shoulder strap pad that provides relief from the normal discomfort associated with shoulder straps, while maintaining the desired aesthetic appearance even after repeated machine washings.

The present invention having been thus described with particular reference to the preferred forms thereof, it will be obvious that various changes and modifications may be made therein without departing from the spirit and scope of the present invention as defined in the appended claims.

What is claimed is:

1. A brassiere shoulder strap pad assembly comprising:
a first top fabric layer having a first side and a second side, a first adhesive web layer having a first side and a second side, said second side of said first top fabric layer being positioned on said first side of said first adhesive web layer, said second side of said first adhesive web layer being positioned on a first base layer;
a second adhesive web layer having a first side and a second side, said second side of second adhesive web layer being positioned on a second base layer;
a cushion filler having a third adhesive web layer, a cushion layer, a fourth adhesive web layer, and a third base layer, said third adhesive web layer, said cushion layer, said fourth adhesive web layer, and said third base layer each having a first side and a second side, said second side of said third adhesive web layer being positioned on said first side of said cushion layer, said second side of said cushion layer being positioned on said first side of said fourth adhesive web layer, said second side of said fourth adhesive web layer being positioned on a third base layer,
wherein said pad assembly is laminated together by heat and adhesive.

2. The brassiere shoulder strap pad assembly of claim 1, wherein said first top fabric layer and said first base layer are made of a nylon yarn.

3. The brassiere shoulder strap pad of claim 1, wherein said second top fabric layer and said first base layer are made of a three bar tricot or knit marquisette fabric.

4. The brassiere shoulder strap pad of claim 1, wherein said first top fabric layer, said first adhesive web layer, and said first base layer form a top cover for said pad assembly.

5. The brassiere shoulder strap pad of claim 1, wherein said first, second, third and fourth adhesive web layers each are made of a nylon adhesive web.

6. The brassiere shoulder strap pad of claim 1, wherein said nylon adhesive web is a polyamide.

7. The brassiere shoulder strap pad of claim 7, wherein said nylon adhesive web has a fusing temperature range of 200 to 230 degrees Fahrenheit.

8. The brassiere shoulder strap pad of claim 1, wherein said cushion filler is a non-woven fiberfill web.

9. The brassiere shoulder strap pad of claim 1, wherein said cushion filler is made of polyester.

10. The brassiere shoulder strap pad of claim 1, wherein said third base layer is made of polyester.

11. The brassiere shoulder strap pad of claim 1, wherein said third base layer is made of mesh.

12. The brassiere shoulder strap pad of claim 1, wherein said second base layer is made of polyester fleece.

13. The brassiere shoulder strap pad of claim 1, wherein said second base layer is a two bar tricot knit fabric.

14. The brassiere shoulder strap pad of claim 1, wherein said second adhesive layer and said second base layer form a bottom cover for said pad assembly.

15. A method of making a brassiere shoulder strap pad which comprises:
laminating a first top fabric layer, a first adhesive web layer, and a first base layer together to form a top cover;
laminating a second adhesive layer and a second base layer together to form a bottom cover;
inserting a cushion filler between said top cover and said bottom cover; and
laminating said top cover to said bottom cover.
